(19) United States
(12) Patent Application Publication
(10) Pub. No.: US 2017/0030257 A1
(43) Pub. Date: Feb. 2, 2017

(54) ENHANCING CYLINDER DEACTIVATION BY ELECTRICALLY DRIVEN COMPRESSOR

(71) Applicant: GM Global Technology Operations LLC, Detroit, MI (US)

(72) Inventors: Ko-Jen WU, Troy, MI (US); Alan W. HAYMAN, Romeo, MI (US); Robert GALLON, Northville, MI (US)

(21) Appl. No.: 14/813,857

(22) Filed: Jul. 30, 2015

(51) Int. Cl. F02B 37/04; F02B 39/16; F02D 41/00; F02B 39/10

(52) U.S. Cl. CPC F02B 37/04; F02B 39/10; F02B 39/16; F02D 41/0007; F02D 41/0087; F02D 2041/0012

(57) ABSTRACT

An electrically driven compressor is used to supplement a turbocharger on an engine featuring cylinder deactivation to alleviate the shortcomings of a single turbocharger in order to extend the deactivated operating ranges. The electrically driven compressor is also operable to enhance transient boost development of a turbocharged engine.

### FIELD

The present disclosure relates to an internal combustion engine having enhanced cylinder deactivation by an electrically driven compressor.

### BACKGROUND

This section provides background information related to the present disclosure which is not necessarily prior art.

Cylinder deactivation is a technology that is often applied to naturally aspirated internal combustion engines to improve the engines' efficiencies under part-load conditions by switching off a selected number of cylinders so the remaining cylinders would operate with reduced pumping losses.

Cylinder deactivation can be applied to turbocharged engines. However, when an engine is equipped with a single turbocharger, the operating ranges of the engine in the deactivated mode can be limited by the turbocharger compressor's flow and boost pressure capabilities. It is a turbocharger compressor's characteristics that, at a given compressor speed, it has a limited flow range as bounded by the surge and choke limits. Since this flow range shifts to high flows with increasing compressor speed, the compressor's operation can be matched to an engine in a typical single-turbocharger application such that at low engine speeds, thus low flow rates, the compressor would operate near the surge limits and the requirement of increasing flow rate with engine speed is met by increasing the compressor speed. In the mid- and high-speed ranges of the engine, the flow requirements can be met by the bulk of the compressor map. This type of matching is illustrated in FIG. 4 by the engine operating curve, that resides within the turbocharger compressor's map.

As the engine switches to the deactivated mode at the same boost levels, the flow rate requirements would reduce as some of the engine cylinders are no longer breathing air. Therefore, the flow requirement curve would shift to lower flow rates on the compressor operating map. The amounts of flow rate changes would depend on the deactivation implementation. For the common practice of deactivating half of the cylinders, such as 6 cylinders to 3 or 4 cylinders to 2, the compressor operating points under the deactivated mode can fall outside of the compressor surge limits, especially in the low-engine-speed range which is more relevant to a typical vehicle driving schedule, as shown by the dots relative to the compressor map in FIG. 4. Even for the points which are within the compressor map of FIG. 4, the compressor would be operating at efficiencies less than the optimum value.

The flow limitation of a single turbocharger application becomes even more severe as the engine flow requirements can be extended to an even lower range by the dynamic skip fire technology relative to a fixed-cylinder deactivation application. To provide boost in the deactivated mode would require a turbocharger system with extended flow and boost capabilities.

The engine's operating ranges in the deactivated mode can also be limited by combustion under higher loads in the active cylinders, e.g., engine knock for gasoline engines and NOx and smoke emissions for diesel engines. Exhaust gas recirculation (EGR), particularly a low-pressure system, has been demonstrated to alleviate such combustion limitations. To implement EGR also would require a turbocharger system with extended flow and boost capabilities.

### SUMMARY

This section provides a general summary of the disclosure, and is not a comprehensive disclosure of its full scope or all of its features.

The present disclosure regards the use of an electrically driven compressor (EDC) to supplement a turbocharger on an engine featuring cylinder deactivation to alleviate the shortcomings of a single turbocharger in order to extend the deactivated operating ranges, in addition to the electrically driven compressor application as a means to enhance transient boost development of a turbocharged engine.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an electrically driven compressor on a turbocharged engine featuring cylinder deactivation;

FIG. 2 is a schematic view of an alternative electrically driven compressor on a turbocharged engine featuring cylinder deactivation;

FIG. 3 is a schematic view of an electrically driven compressor on a turbocharged engine featuring cylinder deactivation by dynamic skip firing;

FIG. 4 is a graph illustrating engine operating points in the deactivated mode superimposed on a single-turbocharger compressor map along with the operating line of a typical engine with all cylinders in operation; and

FIG. 5 is a graph illustrating engine operating points in the deactivated mode superimposed on an electrical driven compressor map according to the principles of the present disclosure that is sized for the same engine as illustrated in the graph of FIG. 4.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

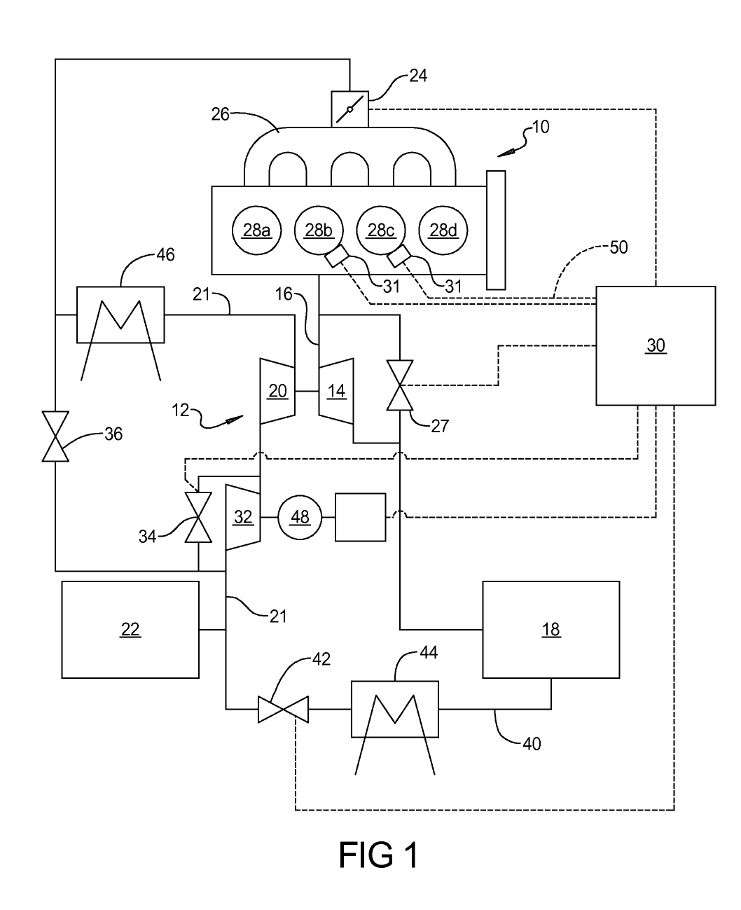

With reference to FIG. 1, a vehicle powertrain system including an exemplary inline four-cylinder internal combustion engine 10 is shown with a turbocharger 12. The turbocharger 12 includes a turbine 14 connected to an exhaust passage 16 of an exhaust system 18 that releases the exhaust gasses to the environment. The turbine 14 is drivingly connected to a compressor 20 that is in connected to an intake passage 21 of an intake system 22 for compressing the intake air and delivering the compressed intake air to an intake throttle 24 and an intake manifold 26 of the engine 10. A bypass valve 27 is provided that allows the exhaust gasses to bypass the turbocharger 12.

The engine 10, as shown, is an inline four cylinder engine including cylinders 28a-d, although other engine architectures can be used. The engine 10 includes an engine controller 30 with cylinder deactivation control such that the middle cylinders can be taken out of service in producing power under appropriate load and speed conditions as demanded by the vehicle driving conditions. Cylinder deactivation mechanisms 31 are known for deactivating the cylinders and, without intending to be limited by example, can include a rocker deactivation device, hydraulic or solenoid controlled deactivation of intake and exhaust valves or valve lifters, selectable cam lobes or other known devices that are capable of cylinder deactivation. For other engine architectures like inline-6, V6, etc., appropriate deactivated cylinders can be chosen based on, e.g., firing order considerations. The system further encompasses an extra electrically driven compressor 32 arranged in a sequential fashion upstream in the intake system 22 of the turbocharger compressor 20. A bypass valve 34 is provided for selectively allowing intake air to bypass the electrically driven compressor 32 when it is not in operation. An additional bypass valve 36 is provided to allow the intake air to bypass both the electrically driven compressor 32 and the turbocharger compressor 20, or alternatively to allow the intake air to bypass just the turbocharger compressor 20. A low-pressure exhaust gas recirculation passage 40 is connected between the exhaust system 18 and the intake system 22 and includes an exhaust gas recirculation control valve 42 that can be controlled by the controller 30. A heat exchanger 44 can be provided within the exhaust gas recirculation passage 40. An additional charge air cooler 46 can be provided downstream of the turbocharger compressor 20.

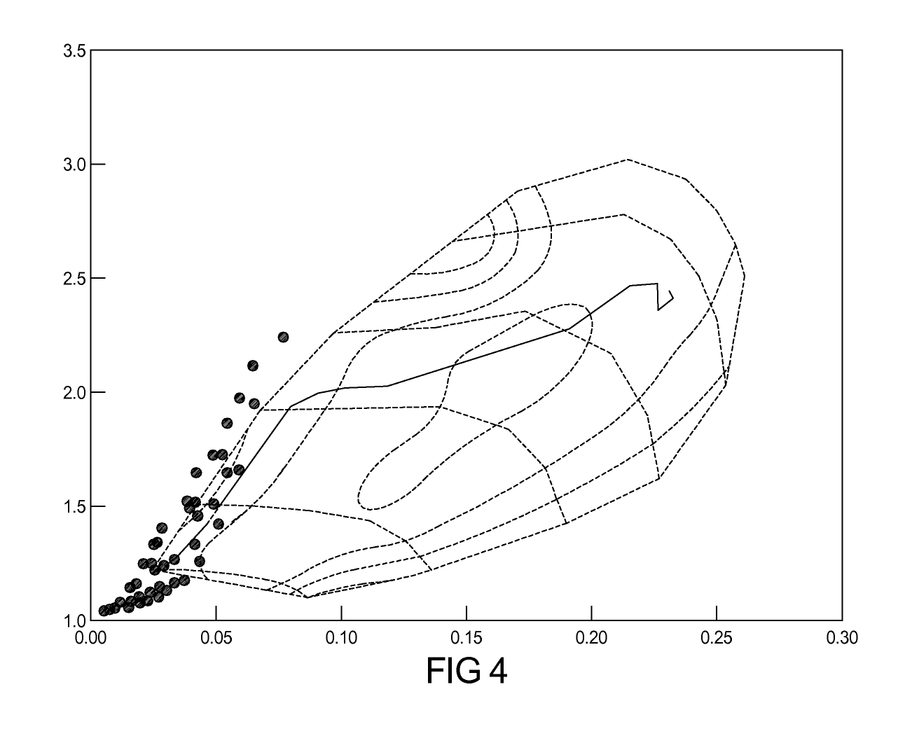

The controller 30 can selectively control the intake throttle valve 24, the cylinder deactivation mechanisms 31, the bypass valves 27, 34, 42 and a controller of a motor 48 of the electrically driven compressor 32. The controller 30 is used to control the cylinder deactivation mechanisms 31 along with the fuel flow (via fuel injectors) to the cylinders 28 and coordinate the electrically driven compressor operation and its bypass valve according to the mode of operation of the engine. In particular, when the engine load demand is low, the controller deactivates the cylinders 28b, 28c and activates the electrically driven compressor to provide a boost operation that is outside of the efficient operating range of the turbocharger map shown in FIG. 4. In addition, the controller controls a throttle body, which regulates engine's load, by regulating the inlet flow rates. The controller also controls the EGR valve, if equipped.

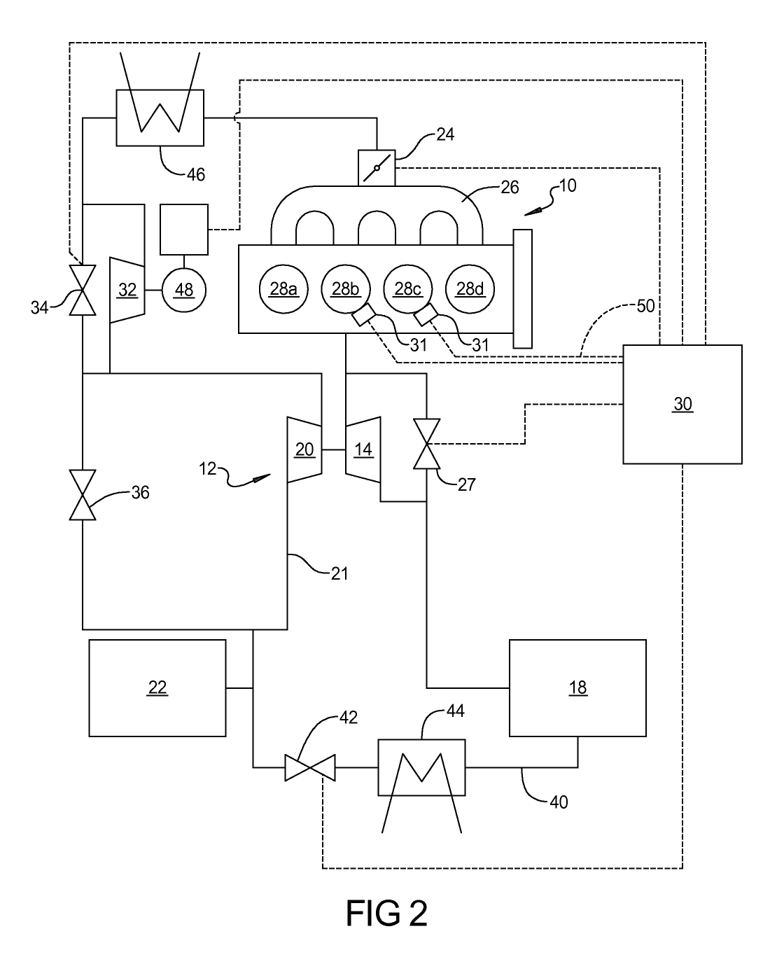

As an alternative arrangement, as shown in FIG. 2, the electrically driven compressor 32 can be positioned downstream of the turbocharger compressor 20. In the embodiment as shown, only a single charge air cooler 46 is shown downstream of the electrically driven compressor 32. If necessary, each boosting device 12, 32 can be equipped with a dedicated charge air cooler.

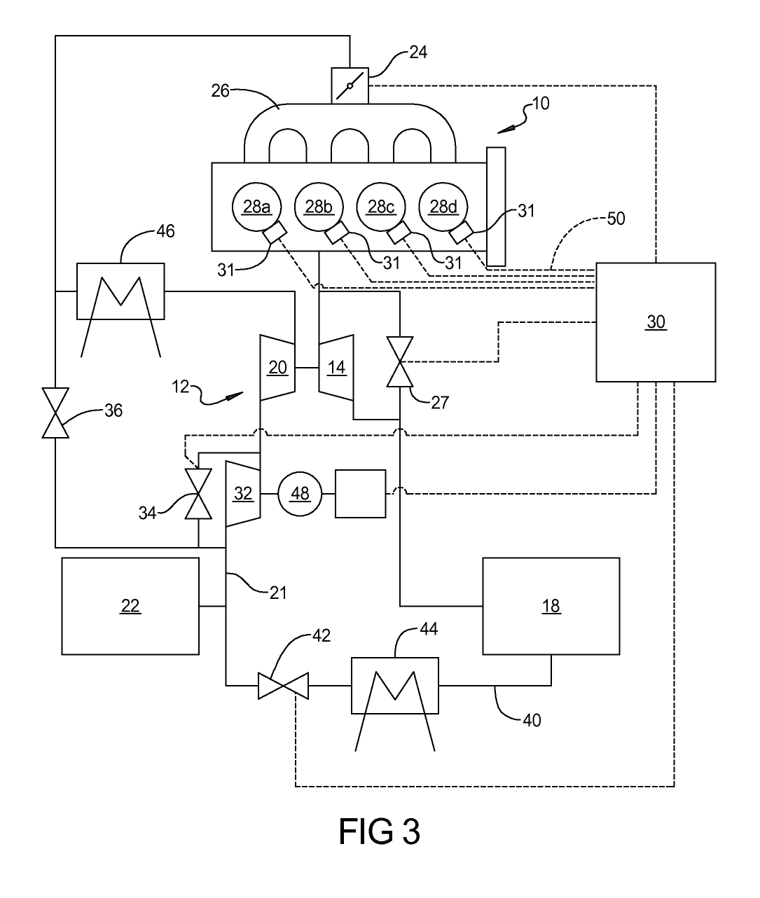

FIG. 3 shows an engine wherein cylinder deactivation is implemented by dynamic skip firing. Dynamic skip firing uses firings or non-firings of engine cylinders to satisfy engine torque demand rather than throttling or other torque reduction mechanisms which reduce thermal efficiency. With dynamic skip firing, as the torque demand increases, the occurrence of firing cylinders increases. The controller 30 will coordinate the electrically driven compressor 32 operation with the selection of firing frequency of the cylinders. As shown in FIG. 3, the controller provides control signals via control lines 50 to deactivation mechanisms 31 associated with each of the cylinders.

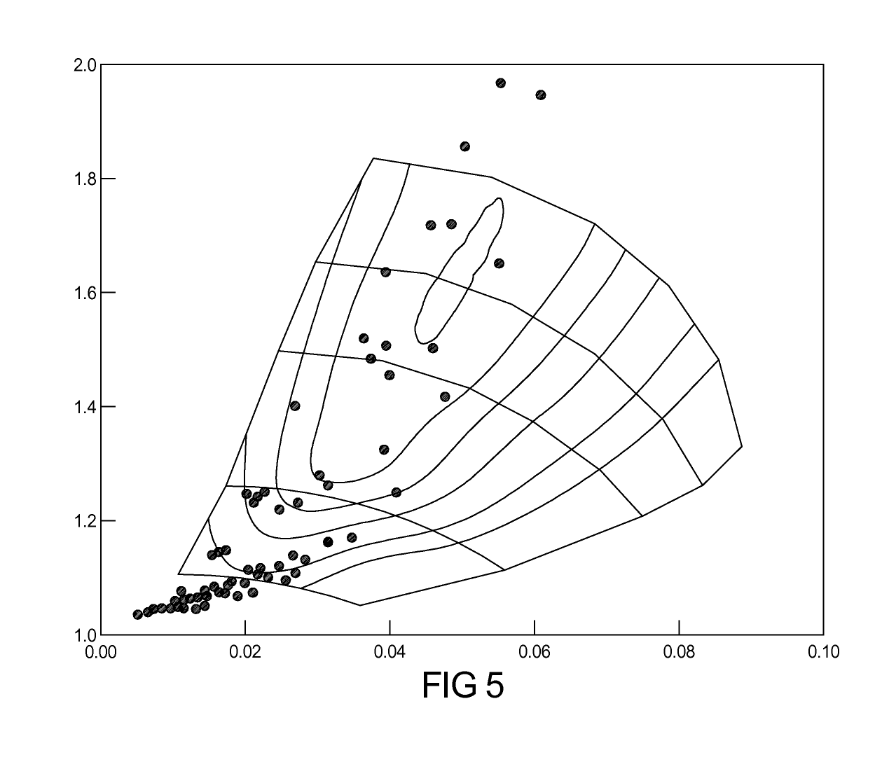

Since the turbocharger 12 is sized to cover the flow requirements for the full-engine operation over the engine operating speed range, the electrically driven compressor 32 is of a size smaller than the turbocharger compressor 20 as it is intended to cover the lower-speed range of the engine operation during vehicle transient maneuvers before the turbocharger 12 spools up to desired speeds. FIG. 5 shows the compressor map of an electrically driven compressor 32 intended for such application. Also superimposed on the electrically driven compressor map are the steady-state flow requirements for the same engine when half of its cylinders or a sub-set of the cylinders are deactivated to illustrate the potential of using the same electrically driven compressor in fulfilling the flow requirements for both modes of operation.

An electrically driven compressor 32 that is typically applied to enhance the transient response of a turbocharged engine when operated in the full-engine mode can be applied to enhance the engine's operation when a selected number of its cylinders are deactivated either by the fixed-cylinder or dynamic skip firing means. This arrangement can broaden the operating load range of the engine when operated in the deactivated mode and thus improve the engine's efficiency characteristics.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A powertrain system, comprising:
an internal combustion engine defining a plurality of cylinders;
an exhaust system in communication with said plurality of cylinders;
an intake system in communication with said plurality of cylinders;
a turbocharger including a turbine in communication with the exhaust system and a compressor in communication with the intake system;
an electrically driven compressor in communication with the intake system;
a cylinder deactivation mechanism associated with at least one cylinder for deactivating the at least one cylinder; and
a controller for controlling the electrically driven compressor in response to a deactivation of said at least one cylinder.

2. The powertrain system according to claim 1, further comprising an exhaust gas recirculation passage in communication between the exhaust system and the intake system.

3. The powertrain system according to claim 1, wherein the electrically driven compressor is upstream of the turbocharger compressor within the intake system.

4. The powertrain system according to claim 1, wherein the electrically driven compressor is downstream of the turbocharger compressor within the intake system.

5. The powertrain system according to claim 1, further comprising a bypass passage in the intake system and including a bypass valve controlled by the controller for bypassing the electrically driven compressor.

6. A powertrain system, comprising:
an internal combustion engine defining a plurality of cylinders;
an exhaust system in communication with said plurality of cylinders;
an intake system in communication with said plurality of cylinders;
an electrically driven compressor in communication with the intake system;
a cylinder deactivation mechanism associated with at least one cylinder for deactivating the at least one cylinder; and
a controller for controlling the electrically driven compressor in response to a deactivation of said at least one cylinder.

7. The powertrain system according to claim 6, further comprising an exhaust gas recirculation passage in communication between the exhaust system and the intake system.

8. The powertrain system according to claim 6, further comprising a bypass passage in the intake system and including a bypass valve controlled by the controller for bypassing the electrically driven compressor.

9. A powertrain system, comprising:
an internal combustion engine defining a plurality of cylinders;
an exhaust system in communication with said plurality of cylinders;
an intake system in communication with said plurality of cylinders;
a turbocharger including a turbine in communication with the exhaust system and a compressor in communication with the intake system;
an electrically driven compressor in communication with the intake system;
a dynamic skip fire mechanism associated with each cylinder for selectively deactivating cylinders in response to a load demand on the engine; and
a controller for controlling the electrically driven compressor in response to a deactivation of said cylinders.

10. The powertrain system according to claim 9, further comprising an exhaust gas recirculation passage in communication between the exhaust system and the intake system.

11. The powertrain system according to claim 9, wherein the electrically driven compressor is upstream of the turbocharger compressor within the intake system.

12. The powertrain system according to claim 9, further comprising a bypass passage in the intake system and including a bypass valve controlled by the controller for bypassing the electrically driven compressor.

13. The powertrain system according to claim 9, wherein the electrically driven compressor is downstream of the turbocharger compressor within the intake system.

14. A powertrain system, comprising:
an internal combustion engine defining a plurality of cylinders;
an exhaust system in communication with said plurality of cylinders;
an intake system in communication with said plurality of cylinders;
an electrically driven compressor in communication with the intake system;
a dynamic skip fire mechanism associated with each cylinder for selectively deactivating cylinders in response to a load demand on the engine; and
a controller for controlling the electrically driven compressor in response to a deactivation of said cylinders.

15. The powertrain system according to claim 9, further comprising an exhaust gas recirculation passage in communication between the exhaust system and the intake system.

16. The powertrain system according to claim 9, further comprising a bypass passage in the intake system and including a bypass valve controlled by the controller for bypassing the electrically driven compressor.
